(19) United States
(12) Patent Application Publication
(10) Pub. No.: US 2021/0245111 A1
(43) Pub. Date: Aug. 12, 2021

(54) TECHNIQUE FOR MANUFACTURING HIGH SOLUTE-SELECTIVE THIN FILM COMPOSITE MEMBRANES USING AROMATIC HYDROCARBON SOLVENTS

(71) Applicant: Korea University Research and Business Foundation, Seoul (KR)

(72) Inventors: Jung-hyun LEE, Seoul (KR); Sung Joon PARK, Seoul (KR); Hyo Eun KWON, Seoul (KR); Soon Jin KWON, Daejeon (KR)

(73) Assignee: Korea University Research and Business Foundation, Seoul (KR)

(21) Appl. No.: 17/049,647

(22) PCT Filed: Apr. 23, 2019
(86) PCT No.: PCT/KR2019/004899

§ 371 Date: Oct. 22, 2020

(30) Foreign Application Priority Data
Apr. 23, 2018 (KR) 10-2018-0046928

(51) Int. Cl. B01D 69/12; B01D 67/00; B01D 69/02; B01D 69/10; B01D 71/56; C02F 1/44

(52) U.S. Cl. CPC B01D 69/12; B01D 67/0006; B01D 69/02; B01D 69/105; C02F 2103/08; C02F 1/441; C02F 1/445; B01D 2325/04; B01D 71/56

(57) ABSTRACT

The present invention relates to a thin film composite membrane and a manufacturing method therefor. The thin film composite membrane according to the present invention has superior water flux and excellent salt (NaCl) rejection and/or boron rejection.

### TECHNICAL FIELD

The present invention relates to a method of manufacturing a thin film composite (TFC) membrane using an aromatic hydrocarbon solvent and a thin film composite membrane manufactured by the above method.

### BACKGROUND ART

Separation membranes, which are used in water treatment and seawater desalination, are generally manufactured in the form of a thin film composite in which a selective layer is adhered to a porous support. The selective layer is prepared by interfacial polymerization of two organic monomers dissolved in two mutually immiscible solvents on the support.

In the case of a commercially available reverse osmosis (RO) membrane, generally, an interface is formed on a porous polysulfone support with a pore size of 1 nm to 10 μm using an aqueous amine monomer solution and an acyl chloride monomer solution dissolved in an organic solvent (usually n-hexane), and a crosslinked polyamide selective layer is formed by condensation polymerization of the monomers at the formed interface.

In general, the concentration of boron present in fresh water is 0.03 ppm or less, which is not problematic. However, the concentration of boron present in seawater ranges from 4 to 5 ppm which is a high level, and at this concentration, disorders in animals and plants and human reproductive function may be caused. For this reason, according to the WHO and EU guidelines for drinking water quality, the concentration of boron is set to 0.5 ppm or less and 1 ppm or less, respectively.

However, since boron is present in the form of boric acid (H₂BO₃), which is a non-ionic species, in seawater, it has been reported that the removal of boron using a common RO membrane is difficult. Currently, when a common RO membrane is used, the boron rejection is about 60 to 70% under the Brackish RO process pressure condition (15.5 bar), which falls short of the WHO standard for water quality.

Accordingly, there is ongoing research on RO membranes which have high boron rejection when used in seawater desalination.

Meanwhile, a forward osmosis (FO) separation technology is a water treatment process technology that separates materials using the osmotic pressure generated by a concentration difference without external driving pressure, unlike the RO separation technology that requires the application of pressure in the presence of a semipermeable membrane between two compartments. This technology can be applied in various process fields such as low-energy seawater desalination and demineralization, water treatment such as sewage/wastewater treatment, purification of foods and bioproducts, energy production through saline-gradient power generation, and the like.

Recently, FO membranes have been developed in the form of a thin film composite form composed of a porous support and a thin film selective layer to improve water flux. The performance of the FO membrane is affected by not only the selective layer but also the physicochemical structure of the support. That is, for the FO membrane to have high water flux, it is preferable to use a support which has high hydrophilicity, high porosity, and high pore connectivity and also has low thickness so as to minimize internal concentration polarization (ICP) in the support. In addition, to prepare a selective layer with high selectivity, it is preferable to use a support with small and uniform pores.

Meanwhile, ideal separation membranes should be applicable in various application environments by having not only high separation performance but also excellent mechanical/chemical durability.

To date, various polymers such as polysulfone (PSF), polyethersulfone (PES), polyacrylate, polyacrylonitrile (PAN), polyketone, and the like have been used as the support. However, PSF cannot be used in the disposal of contaminants containing organic solvents (DMF, NMP, toluene, THF, etc.), such as wastewater from plants or chemical synthetic waste, due to its low durability against the organic solvents.

### DISCLOSURE

### Technical Problem

A composite membrane manufactured by the prior art was unable to reject enough boron to satisfy the WHO standard for water quality.

Therefore, the present invention is directed to providing a thin film composite membrane which has an excellent boron rejection compared to the conventional separation membrane.

The present invention is also directed to providing a thin film composite membrane which has excellent water flux, an excellent salt rejection, and excellent salt selectivity.

### Technical Solution

One aspect of the present invention provides a method of manufacturing a thin film composite membrane, which includes forming a selective layer on a support, wherein the selective layer is prepared by sequentially impregnating or coating a support with a first solution containing a first organic monomer and a first solvent and a second solution containing a second organic monomer and a second solvent and inducing interfacial polymerization of the first solution and the second solution, and the second solvent is toluene, xylene, cumene or dibutyl phthalate.

Another aspect of the present invention provides a thin film composite membrane which is manufactured by the above-described method and includes a support and a selective layer formed on the support.

### Advantageous Effects

A method of manufacturing a thin film composite membrane according to the present invention uses toluene, xylene, cumene, or dibutyl phthalate as an organic solvent in the preparation of a selective layer, and thus the diffusion of an amine monomer into an organic solvent phase can be accelerated during an interfacial polymerization process, thereby significantly improving the synthesis rate of a selective layer. Accordingly, a selective layer having significantly lower thickness and higher crosslinking density than that of the conventional thin film composite membrane can be prepared.

A thin film composite membrane according to the present invention has excellent salt (NaCl) and solute rejections, excellent water flux, and excellent salt selectivity compared to the conventional thin film composite membrane and commercially available thin film composite membranes. In particular, the thin film composite membrane according to the present invention has an outstanding boron rejection and thus can be efficiently used as a thin film composite membrane for water treatment.

### DESCRIPTION OF DRAWINGS

FIG. 1 is a graph illustrating the diffusion rate of a first organic monomer (MPD) dissolved in a first solvent (water) into a second solvent (n-hexane or toluene). This graph illustrates the concentration ratio of MPD dissolved in the first solvent and the second solvent over time.

FIG. 2 is a set of images comparing the surface structures of selective layers of thin film composite membranes manufactured using toluene, xylene, or n-hexane.

FIG. 3 is a set of images comparing the cross-sectional structures of thin film composite membranes manufactured using toluene, xylene, and n-hexane.

### MODES OF THE INVENTION

Hereinafter, a method of manufacturing a thin film composite membrane according to the present invention will be described in detail.

The thin film composite membrane according to the present invention may be manufactured by forming a selective layer on a support.

In the present invention, the support serves to support the selective layer and enhance the mechanical strength of the thin film composite membrane. The support may have a porous structure.

As the support, a commercially available product or a synthesized product may be used. The support may be formed of a resin selected from the group consisting of polyacrylonitrile (PAN), polyethylene (PE), polypropylene (PP), polytetrafluoroethylene (PTFE), polyvinylidene fluoride (PVDF), cellulose acetate, polyimide (PI), polyetherimide (PEI), polyvinylpyrrolidone (PVP), polysulfone (PSF), polyethersulfone (PES), and polybenzimidazole (PBI).

The method according to the present invention may further include, before the formation of a selective layer on a support, hydrophilizing the support.

The hydrophilization treatment results in an increase in the surface energy of the support, and thus the bonding strength of the support with the selective layer may be enhanced. Such hydrophilization treatment may be performed on one surface or both surfaces of the support, and when the hydrophilization treatment is performed on one surface, the surface on which the selective layer is to be formed may be hydrophilized. Generally, when the support is hydrophobic, the hydrophilization treatment may facilitate the formation of the selective layer.

Such hydrophilization treatment may be performed by chemical oxidation, plasma oxidation, UV oxidation, atomic layer deposition (ALD), chemical vapor deposition (CVD), inorganic coating, or polymer coating.

The chemical oxidation may use an acidic solution containing hydrochloric acid, sulfuric acid, nitric acid, hydrogen peroxide, or sodium hypochlorite or a basic solution containing sodium hydroxide, potassium hydroxide, or ammonium hydroxide, and the plasma oxidation may allow one surface or both surfaces of the support to be treated. The inorganic coating may use copper oxide, zinc oxide, titanium oxide, tin oxide, aluminum oxide, or the like as an inorganic material, and the polymer coating may use a hydrophilic compound such as polyhydroxyethylenemethacrylate, polyacrylic acid, polyhydroxymethylene, polyallylamine, polyaminostyrene, polyacrylamide, polyethylenimine, polyvinyl alcohol, polydopamine, or the like as a polymer.

In an embodiment, in order to increase the hydrophilicity of the support, a support made of polyacrylonitrile (PAN) may be treated with a strong base, a support made of polysulfone (PSF) may be treated with sulfuric acid, and a support made of polyvinylidene fluoride (PVDF) may be treated with dry oxygen plasma. In addition, a support made of polyethylene (PE) may be treated with oxygen plasma or a polymer.

In the present invention, after the hydrophilization treatment, washing the support may be further included. As a solvent used in the washing, isopropyl alcohol, water, or a mixed solvent thereof may be used.

In the present invention, the selective layer is formed on the support. The selective layer is a highly dense and crosslinked thin film and has a smooth surface.

In the present invention, the selective layer may be formed by an interfacial polymerization method, a dip coating method, a spray coating method, a spin coating method, or a layer-by-layer assembly method. In the present invention, the selective layer may be formed by the interfacial polymerization method.

In the present invention, the formation of the selective layer by the interfacial polymerization may be performed by sequentially impregnating or coating the support with a first solution containing a first organic monomer and a first solvent and a second solution containing a second organic monomer and a second solvent and inducing interfacial polymerization of the first solution and the second solution.

In an embodiment, there is no particular limitation on the type of the first organic monomer, and, for example, one or more selected from the group consisting of m-phenylenediamine (MPD), p-phenylenediamine (PPD), o-phenylenediamine (OPD), resorcinol, diethylenetriamine (DETA), methanediamine (MDA), piperazine (PIP), N-aminoethyl piperazine (N-AEP), triethylenetetramine (TETA), diethyl propyl amine (DEPA), isophoronediamine (IPDA), 4,4′-diaminodiphenyl methane (DDM), m-xylenediamine (MXDA), 4,4′-diaminodiphenyl sulfone (DDS), and hydroxyalkylamine, all of which are molecules having amine or hydroxyl groups, may be used as the first organic monomer. In the first solution, the concentration of the first organic monomer may range from 1 to 10% w/v or from 3 to 6% w/v.

In an embodiment, there is no particular limitation on the type of the first solvent, and, for example, one or more selected from the group consisting of water, methanol, ethanol, propanol, butanol, isopropanol, ethyl acetate, diethyl ether, acetone, and chloroform may be used as the first solvent.

In an embodiment, there is no particular limitation on the type of the second organic monomer, and, for example, one or more selected from the group consisting of trimesoyl chloride (TMC), 1-isocyanato-3,5-benzenedicarbonyl chloride, terephthaloyl chloride, cyclohexane-1,3,5-tricarbonyl chloride, and isophthaloyl chloride, all of which are molecules having acyl chloride groups, may be used as the second organic monomer. In the second solution, the concentration of the second organic monomer may range from 0.01 to 4% w/v or from 0.1 to 2% w/v.

In addition, the second solvent (organic solvent) may be toluene, xylene, cumene, or dibutyl phthalate. The xylene may be m-xylene, o-xylene, or p-xylene, and a mixture thereof may be used.

In an embodiment of the present invention, toluene or xylene may be used as the second solvent.

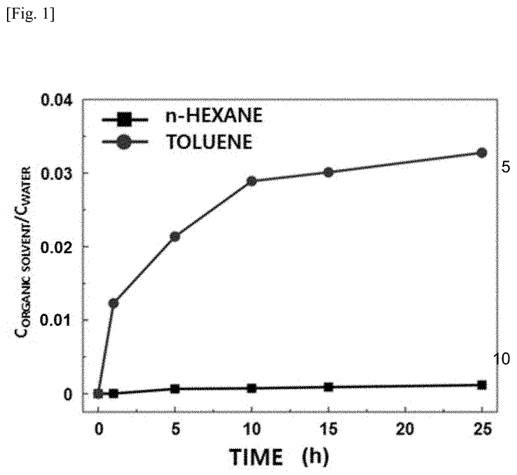

In a conventional method of manufacturing a thin film composite membrane, an aliphatic hydrocarbon-based solvent such as n-hexane or the like is used as the organic solvent. When n-hexane is used, a thin film composite membrane has boron rejection of about 60% (i.e., low efficiency) and low water flux (Comparative Example 1 in the present invention). In the present invention, since the solvents listed above are used as the organic solvent, the diffusion of the first organic monomer into the organic solvent phase is accelerated, and thus a highly selective thin film composite membrane with excellent boron rejection may be manufactured. In addition, the thin film composite membrane according to the present invention has excellent separation properties in terms of water flux, salt (NaCl) rejection, and salt selectivity as well as boron rejection. This result can be attributed to the significantly enhanced diffusion rate of MPD into toluene compared to n-hexane as shown in FIG. 1 illustrating the comparison of the diffusion rate of MPD into toluene or n-hexane.

In an embodiment of the present invention, the first solution contains an amine monomer, and the second solution contains an acyl chloride monomer, and accordingly, a polyamide selective layer may be synthesized by interfacial polymerization of the monomers.

In an embodiment, after the application of a first solution on the support, removing the excess first solution on the support surface may be further included. In this case, the removal of the first solution is preferably performed using an air gun or a roller, but the present invention is not particularly limited thereto.

The method according to the present invention may further include, after the formation of a selective layer, washing the selective layer.

In addition, the present invention provides a thin film composite membrane manufactured by the above-described method of manufacturing a thin film composite membrane.

The thin film composite membrane may include a support and a selective layer formed on the support.

In the present invention, the support has a porous structure and serves to support the selective layer and enhance the mechanical strength of the thin film composite membrane. As a support, the above-described support may be used.

In the present invention, there is no particular limitation on the thickness of the support, and, for example, the support may have a thickness of 5 to 200 μm, 10 to 200 μm, or 20 to 170 μm. Within the above-described thickness range, excellent performance as a thin film composite membrane can be realized. Even when the thickness of the support is more than 200 μm, physical properties and performance that are required for use as a thin film composite membrane are achieved, but water flux may decrease, and manufacturing costs may increase. Therefore, it is preferable to adjust the thickness of the support to 5 to 200 μm.

In addition, the support may have a pore size of 1 to 10,000 nm, 1 to 100 nm, or 10 to 30 nm. Additionally, the support may have a porosity of 20 to 90%, 30 to 90%, 40 to 90%, or 50 to 90%. Within the above-described pore size and porosity ranges, excellent physical properties can be achieved.

The support of the present invention may be a support having been subjected to hydrophilization treatment. The hydrophilization treatment is the same as described above.

In the present invention, the selective layer is formed on the support. The selective layer is a highly crosslinked and dense thin film.

The selective layer may include one or more polymers selected from the group consisting of polyamide, polyfuran, polyether-polyfuran, sulfonated polysulfone, polyamide via polyethylenimine, polyamide via polyepiamine, polyvinylamine, polypyrrolidine, polypiperazine-amide, fully aromatic polyamide, semi-aromatic polyamide, crosslinked polyamide, crosslinked fully aromatic polyamide, crosslinked aralkyl polyamide, and a resorcinol-based polymer.

Such a selective layer may have a thickness of 3 nm to 1 μm, 5 to 500 nm, or 5 to 200 nm. Particularly, since an aromatic hydrocarbon such as toluene, xylene, cumene, or dibutyl phthalate is used as the second solvent in the present invention, a selective layer having a low thickness of 5 to 80 nm, 5 to 50 nm, 5 to 30 nm, or 10 to 25 nm may be easily prepared.

The thin film composite membrane according to the present invention may be used in nanofiltration (NF), forward osmosis (FO), pressure assisted osmosis (PAO), pressure retarded osmosis (PRO), or reverse osmosis (RO) processes. In this case, forward osmosis (FO) may be pressure retarded osmosis (PRO) or pressure assisted osmosis (PAO).

In particular, when used in the RO process, the thin film composite membrane according to the present invention has a thin selective layer and exhibits excellent boron rejection and an excellent salt (NaCl) rejection. Such a thin film composite membrane may have boron rejection of 80% or more, 85% or more, 89% or more, or 90% or more and salt (NaCl) rejection of 90% or more, 95% or more, or 99% or more.

Boron rejection and salt (NaCl) rejection refer to a rejection obtained when a 5 ppm boron aqueous solution is permeated through the thin film composite membrane under the operating conditions of a flow rate of 1 L/min, a temperature of 25° C., and a high pressure of 15.5 bar using a cross-flow filtration system.

Therefore, the present invention may provide a thin film composite RO membrane for removing boron or salt (NaCl), which includes a support and a selective layer formed on the support.

In addition, when used in the FO process, the thin film composite membrane according to the present invention exhibits excellent salt (NaCl) rejection.

In an embodiment, when a flow rate of 0.6 L min⁻¹ and a temperature of 25±0.5° C., the thin film composite membrane may have a water flux (J_{w}) of 20 L m⁻²h⁻¹ or more or 30 L m⁻²h⁻¹ or more and a salt selectivity (Jₛ/J_{w}) of 0.3 g L⁻¹ or less.

Therefore, the present invention may provide a thin film composite FO membrane for removing salt (NaCl), which includes a support and a selective layer formed on the support.

### EXAMPLES

### Reference Example 1. Evaluation of the Diffusion Rate of the First Organic Monomer According to the Type of the Solvent

The degree of diffusion of the first organic monomer according to the type of the solvent was measured.

First, 20 mL of an aqueous m-phenylenediamine (MPD) solution (4% w/v) was input in a 50 mL beaker, and 20 mL of an organic solvent was poured thereon. In this case, n-hexane and toluene were used as the organic solvent.

Afterward, the concentration of MPD in the organic solvent phase (n-hexane or toluene) over time (0, 5, 10, 15, and 25 h) was analyzed using high performance liquid chromatography (HPLC). In addition, the amount of MPD diffused into the organic solvent from the aqueous phase was determined and compared, and based on the result, the rate and degree of diffusion of MPD from the aqueous solution to the organic solvent phase were evaluated.

In the present invention, FIG. 1 is a graph illustrating the result of the diffusion rate of MPD dissolved in water into toluene which is an aromatic hydrocarbon and n-hexane which is an aliphatic hydrocarbon over time.

As shown in FIG. 1, it can be seen that MPD exhibited the more enhanced diffusion rate into toluene compared to n-hexane.

### Examples 1 to 4 and Comparative Examples 1 to 3. Manufacture of Thin Film Composite Membrane for Reverse Osmosis

1) Porous Support

A Polyacrylonitrile (PAN) support having a surface pore size of 10 to 30 nm or an oxygen (O₂) plasma-treated or polydopamine-coated hydrophilic polyethylene (PE) support having a surface pore size of 100 to 300 nm was used as a porous support.

In this case, the treatment of the polyethylene support with O₂ plasma was performed at a pressure of 0.09 kPa and a plasma intensity of 20 W for 20 sec using CUTE-MPR (UVFAB Systems Inc.). In addition, the coating of the polyethylene support with polydopamine was performed by dissolving dopamine hydrochloride in a 1:1 mixed solution of a Tris-HCl buffer solution (10 mM) and ethanol (i.e., preparing a dopamine solution (2 g L⁻¹)) and then immersing the support in the dopamine solution at 40° C. for 8 h. 2) Preparation of a Selective Layer

Water was used as a first solvent (hydrophilic solvent) of a first solution, and m-phenylenediamine (MPD) was used as a first organic monomer included in the first solution. In the first solution, the concentration of MPD was 4% w/v.

Toluene, xylene (mixture of o-, m-, and p-xylene, manufactured by Daejung Chemicals & Metals Co., Ltd.), or n-hexane was used as a second solvent (organic solvent) of a second solution (see Table 1), and trimesoyl chloride (TMC) was used as a second organic monomer included in the second solution. In the second solution, the concentration of TMC was 1% w/v.

TABLE 1

| | Support | Solvent of the second solution |
|---|---|---|
| Example 1 | PAN | Toluene |
| Example 2 | | Xylene |
| Comparative | | n-Hexane |
| Example 1 | | |
| Example 3 | O₂ plasma-treated | Toluene |
| Comparative | PE | n-Hexane |
| Example 2 | | |
| Example 4 | Polydopamine-coated | Toluene |
| Comparative | PE | n-Hexane |
| Example 3 | | |

A selective layer was prepared by an interfacial polymerization method as follows.

(1) A support was washed with isopropyl alcohol and water.

(2) The washed support was immobilized in a reaction container, and 20 mL of a first solution was poured to impregnate the support with the first solution.

(3) The first solution was removed, and a trace amount of the first solution remaining on the support surface was removed using an air gun.

(4) A second solution was poured thereon, thereby synthesizing a selective layer by interfacial polymerization. (5) Unreacted second organic monomers were removed by washing with a solvent used in the second solution, and drying was performed at room temperature for 3 min.

(6) The resultant was placed in a 70° C. oven, dried for 5 min, and then stored in room temperature water.

### Comparative Example 4. Commercially Available RO Membrane

A commercially available RO membrane (SWC4+ manufactured by Hydranautics Corporation) was used.

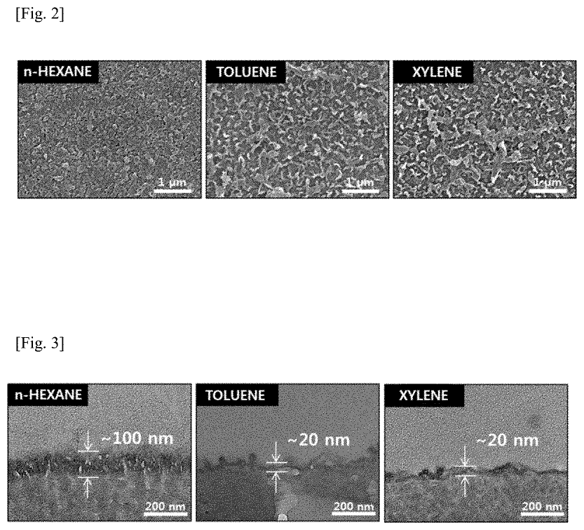

In the present invention, FIGS. 2 and 3 are images illustrating the surface structures (surface structures of selective layers; FIG. 2) and the cross-sectional structures (FIG. 3) of the thin film composite membranes manufactured in Examples 1 and 2 and Comparative Example 1. FIG. 2 is a set of scanning electron microscope (SEM) images, and FIG. 3 is a set of transmission electron microscope (TEM) images.

As shown in FIGS. 2 and 3, when toluene or xylene was used as the second solvent (organic solvent), a selective layer with high density and a low thickness of about 20 nm could be prepared.

The thin film composite membrane according to the present invention has high water flux due to the low thickness of the selective layer and excellent salt rejection due to the high density of the selective layer.

### Experimental Example 1. Performance Experiment

(1) Conditions

The separation performance of the thin film composite membranes according to Examples 1 to 4 and Comparative Examples 1 to 4 was tested using a cross-flow filtration system (manufactured by SepraTek).

Specifically, a NaCl (2,000 ppm) aqueous solution or a boron (5 ppm) aqueous solution was permeated through each thin film composite membrane under the process conditions of a flow rate of 1 L min⁻¹, a temperature of 25° C., and a pressure of 15.5 bar, and water flux and salt (NaCl) rejection or boron rejection were measured.

Water flux was calculated from the amount of water permeated per unit area of the thin film composite membrane and unit time, and salt or boron rejection was calculated by measuring the concentration of NaCl or boron, respectively, in the feed solution and the permeate solution.

(2) Result

The performance results of the thin film composite membranes are shown in the following Table 2.

TABLE 2

| | | Solvent of | Water | NaCl | Boron |
|---|---|---|---|---|---|
| | Support/ | the second | flux | rejection | rejection |
| | membrane | solution | (L m⁻² h⁻¹) | (%) | (%) |
| Example 1 | PAN | Toluene | 26.1 | 99.9 | 90.3 |
| Example 2 | | Xylene | 25.5 | 99.8 | 89.2 |
| Comparative | | n-Hexane | 8.7 | 96.8 | 60.4 |
| Example 1 | | | | | |
| Example 3 | O₂ plasma- | Toluene | 45.3 | 99.7 | 85.1 |
| Comparative | treated PE | n-Hexane | 26.2 | 99.5 | 82.8 |
| Example 2 | | | | | |
| Example 4 | Polydopamine- | Toluene | 45.5 | 99.7 | 85.4 |
| Comparative | coated PE | n-Hexane | 26.3 | 99.5 | 82.9 |
| Example 3 | | | | | |

| | | | | |
|---|---|---|---|---|
| Comparative | Commercially available RO | 21.0 | 99.1 | 64.8 |
| Example 4 | membrane (SWC4 + | | | |
| | manufactured by Hydranautics | | | |
| | Corporation) | | | |

As shown in Table 2, it can be seen that the thin film composite membranes (for reverse osmosis) according to the present invention showed a performance difference according to the type of the second solvent (organic solvent) used in the manufacture thereof.

Specifically, the thin film composite membranes of Examples 1 to 4, in which an aromatic hydrocarbon, that is, toluene or xylene, was used as the solvent, exhibited excellent water flux and excellent NaCl and boron rejection compared to all of the conventional thin film composite membranes of Comparative Examples 1 to 3, in which n-hexane was used as the solvent, and the commercially available RO membrane of Comparative Example 4.

This is because a conventional thin film composite membrane manufacturing technology (Comparative Examples 1 to 3) does not enable the preparation of a selective layer with low thickness and a high density structure, and accordingly, a thin film composite membrane exhibits low water flux and low salt (NaCl) and boron rejection.

On the other hand, in the present invention, a selective layer with low thickness and high density is prepared, and accordingly, a thin film composite membrane with high water flux and high salt (NaCl) and boron rejection can be manufactured.

### Examples 5 and 6 and Comparative Examples 5 and 6. Manufacture of Thin Film Composite Membranes for Forward Osmosis

1) Porous Support

A polyacrylonitrile (PAN) support having a surface pore size of 10 to 30 nm or a polydopamine-coated hydrophilic polyethylene (PE) support having a surface pore size of 100 to 300 nm was used as a porous support.

In this case, the coating of the polyethylene support with polydopamine was performed as in Example 4.

2) Preparation of a Selective Layer

Water was used as a first solvent (hydrophilic solvent) of a first solution, and m-phenylenediamine (MPD) was used as a first organic monomer included in the first solution. In the first solution, the concentration of MPD was 5% w/v.

Toluene or n-hexane was used as a second solvent (organic solvent) of a second solution, and trimesoyl chloride (TMC) was used as a second organic monomer included in the second solution. In the second solution, the concentration of TMC was 1% w/v.

TABLE 3

| | | Organic solvent of the |
|---|---|---|
| | Support | second solution |
| Example 5 | PAN | Toluene |
| Comparative | PAN | n-Hexane |
| Example 5 | | |
| Example 6 | Polydopamine-coated PE | Toluene |
| Comparative | Polydopamine-coated PE | n-Hexane |
| Example 6 | | |

A selective layer was prepared by an interfacial polymerization method as follows.

(1) A support was washed with isopropyl alcohol and water.

(2) The washed support was immobilized in a reaction container, and 20 mL of a first solution was poured to impregnate the support with the first solution.

(3) The first solution was removed, and a trace amount of the first solution remaining on the support surface was removed using an air gun.

(4) A second solution was poured thereon, thereby synthesizing a selective layer by interfacial polymerization.

(5) Unreacted second organic monomers were removed by washing with a solvent used in the second solution, and drying was performed at room temperature for 3 min.

(6) The resultant was placed in a 70° C. oven, dried for 5 min, and then stored in room temperature water.

### Comparative Example 7

As a thin film composite membrane, a commercially available CTA membrane manufactured by HTI was used.

### Comparative Example 8

As a thin film composite membrane, a commercially available TFC membrane manufactured by HTI was used.

### Experimental Example 2. Performance Experiment

(1) Conditions

The FO performance (water flux, reverse salt flux, and salt selectivity) of the thin film composite membranes according to Examples 5 and 6 and Comparative Examples 5 to 8 in the FO process was compared.

Specifically, the water flux, reverse salt flux, and salt selectivity of the thin film composite membranes were compared using a 1 M NaCl draw solution and DI water feed solution under the process conditions of a flow rate of 0.6 L min⁻¹ and a temperature of 25±0.5° C.

(2) Result

The FO performance results of the thin film composite membranes are shown in the following Table 4.

TABLE 4

| | | Solvent of | | Reverse salt | Salt |
|---|---|---|---|---|---|
| | Support/ | the second | Water flux | flux | selectivity |
| | membrane | solution | (J_{w}, L m⁻² h⁻¹) | (Jₛ, g m⁻² h⁻¹) | (Jₛ/J_{w}, g L⁻¹) |
| Example 5 | PAN | Toluene | 33.4 | 5.6 | 0.17 |
| Comparative | | n-Hexane | 15.6 | 4.8 | 0.31 |
| Example 5 | | | | | |
| Example 6 | Polydopamine- | Toluene | 53.0 | 14.8 | 0.28 |
| Comparative | coated PE | n-Hexane | 26.7 | 9.8 | 0.37 |
| Example 6 | | | | | |
| Comparative | Commercially | — | 11.8 | 6.7 | 0.57 |
| Example 7 | available FO | | | | |
| | membrane (CTA | | | | |
| | manufactured | | | | |
| | by HTI) | | | | |
| Comparative | Commercially | — | 16.0 | 12.1 | 0.76 |
| Example 8 | available FO | | | | |
| | membrane (TFC | | | | |
| | manufactured | | | | |
| | by HTI) | | | | |

As shown in Table 4, it can be seen that the thin film composite membranes (for forward osmosis) according to the present invention showed a performance difference according to the type of the second solvent (organic solvent) used in the manufacture thereof.

Specifically, the thin film composite membranes of Examples 5 and 6, in which an aromatic hydrocarbon, that is, toluene, was used as the solvent, exhibited excellent water flux and excellent salt selectivity compared to all of the conventional thin film composite membranes of Comparative Examples 5 and 6, in which n-hexane was used as the solvent, and the commercially available FO membranes of Comparative Examples 7 to 8.

In the present invention, a selective layer with low thickness and high density is prepared, and accordingly, a thin film composite membrane with high water flux and high salt selectivity can be manufactured.

### INDUSTRIAL APPLICABILITY

A method of manufacturing a thin film composite membrane according to the present invention uses toluene, xylene, cumene, or dibutyl phthalate as an organic solvent in the preparation of a selective layer, and thus diffusion of an amine monomer into an organic solvent phase can be accelerated during an interfacial polymerization process, thereby significantly improving the synthesis rate of a selective layer. Accordingly, a selective layer having significantly lower thickness and higher crosslinking density than that of the conventional thin film composite can be prepared.

A thin film composite membrane according to the present invention has excellent salt (NaCl) and solute rejections, excellent water flux, and excellent salt selectivity compared to the conventional thin film composite membranes and commercially available thin film composite membranes. In particular, the thin film composite membrane according to the present invention has outstanding boron rejection and thus can be efficiently used as a thin film composite membrane for water treatment.

1. A method of manufacturing a thin film composite membrane, comprising forming a selective layer on a support,
wherein the selective layer is prepared by sequentially impregnating or coating a support with a first solution containing a first organic monomer and a first solvent and a second solution containing a second organic monomer and a second solvent and inducing interfacial polymerization of the first solution and the second solution, and
the second solvent is toluene, xylene, cumene or dibutyl phthalate.

2. The method of claim 1, wherein the support is formed of a resin selected from the group consisting of polyacrylonitrile (PAN), polyethylene (PE), polypropylene (PP), polytetrafluoroethylene (PTFE), polyvinylidene fluoride (PVDF), cellulose acetate, polyimide (PI), polyetherimide (PEI), polyvinylpyrrolidone (PVP), polysulfone (PSF), polyethersulfone (PES), and polybenzimidazole (PBI).

3. The method of claim 1, further comprising, before the formation of a selective layer on a support, hydrophilizing the support.

4. The method of claim 3, wherein the hydrophilization treatment is performed by chemical oxidation, plasma oxidation, UV oxidation, atomic layer deposition (ALD), chemical vapor deposition (CVD), inorganic coating, or polymer coating.

5. The method of claim 1, wherein the first organic monomer is one or more selected from the group consisting of m-phenylenediamine (MPD), p-phenylenediamine (PPD), o-phenylenediamine (OPD), resorcinol, diethylenetriamine (DETA), methanediamine (MDA), piperazine (PIP), N-aminoethyl piperazine (N-AEP), triethylenetetramine (TETA), diethyl propyl amine (DEPA), isophoronediamine (IPDA), 4,4′-diaminodiphenyl methane (DDM), m-xylenediamine (MXDA), 4,4′-diaminodiphenyl sulfone (DDS), and hydroxyalkylamine.

6. The method of claim 1, wherein the first solvent is one or more selected from the group consisting of water, methanol, ethanol, propanol, butanol, isopropanol, ethyl acetate, diethyl ether, acetone, and chloroform.

7. The method of claim 1, wherein the second organic monomer is one or more selected from the group consisting of trimesoyl chloride (TMC), 1-isocyanato-3,5-benzenedicarbonyl chloride, terephthaloyl chloride, cyclohexane-1,3,5-tricarbonyl chloride, and isophthaloyl chloride.

8. A thin film composite membrane manufactured by the method of claim 1, comprising:
a support; and
a selective layer formed on the support.

9. The thin film composite membrane of claim 1, wherein the support is a hydrophilized support.

10. The thin film composite membrane of claim 8, wherein the selective layer includes one or more polymers selected from the group consisting of polyamide, polyfuran, polyether-polyfuran, sulfonated polysulfone, polyamide via polyethylenimine, polyamide via polyepiamine, polyvinylamine, polypyrrolidine, polypiperazine-amide, fully aromatic polyamide, semi-aromatic polyamide, crosslinked polyamide, crosslinked fully aromatic polyamide, crosslinked aralkyl polyamide, and a resorcinol-based polymer.

11. The thin film composite membrane of claim 8, wherein the selective layer has a thickness of 3 nm to 1 μm.

12. The thin film composite membrane of claim 1, which is used in a nanofiltration (NF), forward osmosis (FO), pressure assisted osmosis (PAO), pressure retarded osmosis (PRO), or reverse osmosis (RO) process.

13. The thin film composite membrane of claim 12, which has boron rejection of 80% or more when used in the reverse osmosis (RO) process.
